(19) United States
(12) Patent Application Publication
(10) Pub. No.: US 2022/0235434 A1
(43) Pub. Date: Jul. 28, 2022

(54) SIMPLIFIED METHOD OF GOLD RECOVERY FROM ELECTRONIC WASTE

(71) Applicant: LEXMARK INTERNATIONAL, INC., LEXINGTON, KY (US)

(72) Inventors: JODI LYNN WALSH, BERTHOUD, CO (US); WEIMEI LUO, LOUISVILLE, CO (US); MARK THOMAS BELLINO, LOVELAND, CO (US)

(21) Appl. No.: 17/696,175

(22) Filed: Mar. 16, 2022

Related U.S. Application Data
(63) Continuation of application No. 17/583,385, filed on Jan. 25, 2022.
(60) Provisional application No. 63/141,304, filed on Jan. 25, 2021.

(51) Int. Cl. C22B 7/00; C22B 11/00

(52) U.S. Cl. CPC C22B 7/006; C22B 11/042

(57) ABSTRACT

The present invention related to generally to a process to recover metals from waste electronics, and more particularly a process to recover gold from waste electronics. The gold is first delaminated in a first step using a solution containing a weak acid in combination with an oxidizer. The second step isolates and purifies the delaminated gold from the chip debris using solvents, water and a wetting agent/surfactant. The proposed two step method of gold recovery from electronic waste is effective without the need for strong or costly chemicals or leaching.

### CROSS REFERENCE TO RELATED APPLICATIONS

This application is a continuation application of U.S. patent application Ser. No. 17/583,385, filed Jan. 25, 2022, entitled “A Simplified Method of Gold Recovery from Electronic Waste,” that also claims priority to U.S. Provisional Patent Application Ser. No. 63/141,304, filed Jan. 25, 2021, entitled “A Simplified Method of Gold Recovery from E-Waste,” the content of which is hereby incorporated by reference in its entirety.

### BACKGROUND

### 1. Field of the Disclosure

The present invention related to generally to a process to recover metals from waste electronics, and more particularly a process to recover gold from electronic waste. The gold is first delaminated in a first step using a solution containing a weak acid in combination with an oxidizer. The second step isolates and purifies the delaminated gold from the chip debris using solvents, water and a wetting agent/surfactant. The proposed two step method of gold recovery from electronic waste is effective without the need for strong and costly chemicals or toxic leaching.

### 2. Description of Related Art

The production of electrical and electronic equipment has been rapidly increasing due to the revolution of information technology. All electrical and electronic equipment such as smart phones, tablets, desktop/laptop computers contain printed circuit boards (PCBs). Importantly, these PBCs contain a significant amount of valuable base and precious metals, including copper, zinc, lead, nickel and tin and valuable precious metals including gold, silver and palladium. Gold, having superior chemical resistance and electrical conductivity, is widely electroplated on top of copper, copper/nickel electrical contacts in PBCs for added protection from rust, damage and or corrosion.

Technological advancements in electronic equipment have shortened their life span and have caused a massive tonnage of waste (‘e-waste’) to be produced. This e-waste causes multiple environmental challenges. Currently, the base and precious metals contained in PCBs are not sufficiently recovered prior to the disposal of e-waste. E-waste can be disposed of through incineration or placed in a landfill. Both disposal options present environmental challenges. Incineration releases toxins into the air. Landfilling electronic waste can contaminate underground water and soil.

In addition to the recovery of precious and base metals from e-waste being desirable from an environmental standpoint, it is also desirable from an economic standpoint. Cost effective methods of recovering base and precious metals from e-waste are desirable due to the source of income due to the high economic value of gold, silver, palladium, and copper, as well as other metals.

It is therefore desirable to have an adequate recycling process of e-waste, especially waste PCBs, that will prevent environmental pollution. Also desirable is a cost-effective recovery process of base and precious metals especially gold. Currently, methods based on pyrometallurgical and hydrometallurgy techniques are used for the recovery of these metals on PCBs.

Known pyrometallurgical processes are not cost effective nor environmentally friendly on account of the of the use of high temperatures on the waste PCBs to recover the base and precious metals, leading to the production of hazardous gases into the air. Additionally, pyrometallurgical processes are energy intensive and require high cost and capital to start up and maintain the recovery/recycling operation. Based on the above described limitations of using a pyrometallurgy process to recover metals from waste PCBs, hydrometallurgical processes are preferred.

Hydrometallurgical processes of recovery of base and precious metals, especially gold electroplated on top of the copper, from waste PCBs are usually done at a lower cost, have a reduced environmental impact because of the low gas and dust formation, and have higher gold recoveries compared to pyrometallurgical processes. Hydrometallurgical method for gold recovery from security chip and PCBs typically consists of cyanide and non-cyanide processes to dissolve and recover gold. The process typically involves multiple steps like grinding, and leaching, extraction, cementation, or electrowinning.

Due to the high toxicity and environmental impact of using a hydrometallurgical process employing cyanide, there has been a desire to find non-cyanine hydrometallurgical alternatives in recent years. Several known non-cyanide hydrometallurgical processes include the use of a leaching solution having a strong acid in combination with an oxidizing agent such as aqua regia (HNO3+3HCl). Another known leaching solution uses thiosulfate/thiourea. A third leaching solution uses iodine/iodide. However, the use of these leaching solutions to recover gold in PCBs have known drawbacks including high cost and the use of toxic reagents in the leaching solutions. Accordingly, it is desirable to have a hydrometallurgical process to recover gold from e-waste that is both cost effective and environmentally friendly.

### SUMMARY

An aspect of the present invention relates to a method of recovering precious metals from electronic waste. More particularity, the present invention is a method of recovering gold from printed circuit boards found in electronic waste without the need for strong and costly chemicals or toxic leaching. The method of gold recovery from electronic waste is a two-step process. In the first step, the electronic waste containing printed circuit boards having gold electroplated on top of copper electrical contacts is contacted and soaked with a solution containing a weak acid in combination with an oxidizer. After this first step, the electroplated gold becomes delaminated from the electrical contacts to form gold leaf. After the delamination step, the solution contains a mixture of the delaminated gold leaf and chip debris. The next step in the recovery process is the separation and isolation of the gold leaf from the chip debris in the solution. This is accomplished by first adding a solvent and water to the solution containing the delaminated gold leaf mixed with chip debris, then second adding a surfactant to the solution containing the delaminated gold leaf mixed with the chip debris, solvent and water. The surfactant is a polyether siloxane copolymer. After the addition of this particular surfactant, the delaminated gold leaf instantly floats upward in the solution and purified gold is obtained.

### DETAILED DESCRIPTION

Gold is deposited onto copper as a clean contact surface for control boards (PCBs) and other substrates that can be found in e-waste. It is valuable to separate the gold and isolate it for recovery.

The inventive process to recover gold from electronic waste is a multi-step process. The first step places used security chips in a delaminating solution containing a mild, low-cost acid such as acetic acid (vinegar) in combination with an oxidizer such as hydrogen peroxide. After soaking the security chips in the delaminating solution, copper found in the security chips is dissolved and converted to Cu++ (copper II cations). After the security chips are contacted or soaked in this delaminating solution containing a mild acid and an oxidizer, surprisingly the gold film coated on copper or copper/nickel surface contacts on the security chips is no longer attached to the board or chips. This delaminated gold is described as gold leaf. However, unwanted chip debris (what is left behind of the chip, plastic, glass fiber, etc.) is still mixed with the delaminated gold leaf. This delaminated gold leaf must then be separated/isolated from the chip debris, collected and purified to obtain enriched gold.

Known prior art processes to separate/isolate the gold leaf, once delaminated, from the chip debris include a traditional density wet separation technique (gravity separation) and an airflow technique (such as through classification by density as is practiced in the toner manufacturing industry.

The challenge with gold leaf is that it does not lend itself to typical gravity separation techniques that are known in industry (fundamental to ‘gold panning’ kind of technologies).

The applicants have discovered a different process to separate the gold leaf from the chip debris using a selective floatation process. After the delamination step, gold leaf and chip debris are mixed in a bi-layer water/organic system. The inventive selective floatation process is the second step done to recover gold leaf from e-waste. This inventive selective floatation process of the gold leaf from the chip debris in a bi-layer water/organic system is due to the hydrophobic nature of the surface of the gold leaf. This disclosed selective floatation technique leverages both the differential solubility of gold leaf (demonstrated with weak acid) to other metals as well as the hydrophobic nature of the gold leaf to enable a more direct and quick separation and recovery of the gold than has been pursued in methods involving toxic leaching (dissolution) of the gold leaf followed by precipitation.

The addition of a particular surfactant such a polyether siloxane copolymer (Tego Wet 270) to the chip debris and gold leaf mixture surprisingly acts to cause an instant separation of the delaminated gold leaf from the chip debris via an instant floatation of the delaminated gold leaf upward into the top of the organic layer. The hydrophobic nature of the gold leaf allows the gold leaf to float upward away (rather than sinking) from the chip debris. Using this particular type of surfactant allows this selective floatation separation to be extremely effective. After addition of the surfactant to the gold leaf and chip debris mixture, the chip debris sinks in the water, and the gold leaf floats upward into the organic layer, thereby making it easy to isolate the delaminated gold leaf from the chip debris. The organic layer can be any material that is lighter than water and preferable to be non-toxic so as to minimize the environmental impact of the process.

The above described ‘floatation’ idea is known in the mining industry as the Coal Gold Agglomeration (CGA) process. The CGA process uses the hydrophobic nature of the gold surface combined with a suspension of particulates (in common practice, coal dust) in a mixed media (fundamentally oil and water) to agglomerate coal/gold/oil particles that float on the surface of the aqueous media. These agglomerates are buoyant and hard enough that they can then be easily filtered out and separated from the aqueous matrix. Isolation of the gold then requires a pyrometallurgical process to burn off the oil and coal and smelt out the gold. The CGA process and its initial persistence in the mining industry (in the late 1980s) was sufficient to demonstrate both the effectiveness of the system to separate gold particles of various sizes (submicron and millimeter) from a dirty aqueous matrix by flotation as well as the undesirable economics of the necessary smelting step of the process to isolate the gold from the oil and coal. The method of gold recovery of the present invention utilizes the hydrophobic nature of the gold just as the CGA process did but avoids the need to add oil or particulates to ‘float’ the gold and separate it. Without the addition of oil and coal burning of the matrix is no longer necessary to enable isolation of gold of salable purity. The inventive gold recovery method utilizes the physical characteristics of gold leaf as isolated from a laminated surface in combination with the hydrophobic nature of the gold itself. The mining industry did not have the luxury of a pre-refined gold source with a thin leaf profile as our process does due to their source of the gold being a raw ore rather than a laminated substrate. It is therefore necessary to add the oil in the CGA process to encourage agglomeration and fine particles (coal dust) to create low density agglomerates which would float.

The applicants have also used airflow or air loft separation to separate the delaminated gold leaf from chip debris in a dry process leveraging the differential loft of the delaminated gold leaf versus the residual chip debris. In the above described separation methods of ‘floating’ or ‘lofting’ delaminated gold leaf, the delaminated gold leaf is light and floats upward. This is in contrast to the normal gravity separation technique in which the delaminated gold leaf is heavy and is separated from chip debris by sinking downward. Additionally, toner classification techniques can be used for the loft air separation.

### Testing

Security chips (50 g) are soaked in diluted acetic acid (300 ml, 20%) and hydrogen peroxide (25 ml). After one week, the stripped chips are removed by going through a strainer (˜5 mm). Gold flakes are collected by filtration of the blue solutions (Cu++). The mixture of gold and impurities including mostly chip debris was washed with diluted base like sodium carbonate solution, water then acetone. The data in Table 1 below shows the identification of various chemical elements found in the sample after stripping from chips but before further purification step.

TABLE 1
ICP Analysis on the security chips after delamination and filtration steps

| S650740 | | | | | | | | | | | | Sr | | |
|---|---|---|---|---|---|---|---|---|---|---|---|---|---|---|
| (Dec. 22, 2020) Dong | Al % | Au % | B % | Ba % | Ca % | Co % | Cu % | Fe % | Mg % | Na % | Ni % | ppm | Zn % | Total |
| Run1 | 2.000 | 16.929 | 0.501 | 1.980 | 4.476 | 0.041 | 0.614 | 0.173 | 0.117 | 0.094 | 1.587 | 0.058 | 0.023 | 28.592 |
| Run2 | 1.646 | 18.126 | 0.401 | 2.528 | 3.551 | 0.043 | 1.409 | 0.224 | 0.118 | 0.085 | 1.157 | 0.061 | 0.019 | 29.367 |
| Run3 | 1.798 | 15.853 | 0.444 | 2.256 | 3.824 | 0.037 | 1.318 | 0.204 | 0.111 | 0.088 | 0.936 | 0.060 | 0.017 | 26.945 |

The purification process involves the selective precipitation of chip debris using solvent(s), water and a surfactant/wetting agent. Importantly, the selected solvents should not be miscible with water so to maintain two distinct phases, for example, hydrocarbons like hexanes, heptanes, octanes. The gold flakes and some chip debris usually stay in the water-solvent interface. Surfactant/wetting agent is then added to precipitate chip debris to remove unwanted impurities. Surfactant/wetting agent can include but not limit to Tego Wet 270, BYK110, BYK2025. Gold purification can also involve air-blow to separate gold flakes from chip debris.

TABLE 2-1
ICP Analysis on the fractions after purification

| S650740 | | | | | | | | | | | | | | |
|---|---|---|---|---|---|---|---|---|---|---|---|---|---|---|
| (Jan. 6, 2021) | Al % | Au % | B % | Ba % | Ca % | Co % | Cu % | Fe % | Mg % | Na % | Ni % | Sr % | Zn % | Total |
| Fraction 1 | 0.563 | 66.84 | 0.116 | 0.879 | 1.186 | 0.149 | 1.115 | 0.224 | 0.048 | 0.063 | 0.738 | <0.031 | <0.031 | 72.008 |
| Fraction 2 | 1.233 | 3.766 | 0.321 | 2.185 | 2.674 | 0.007 | 2.306 | 0.297 | 0.131 | 0.099 | 0.305 | 0.052 | 0.009 | 13.383 |

This process at its most basic is a delamination of gold leaf followed by isolation of that delaminated gold leaf from chip debris without the need for strong chemicals or leaching. Fraction 1 contains mostly gold (metal content 72% with gold 66.84%) and fraction 2 mostly chip debris (metal content 13.38%). The disclosed gold recovery process is expected to be applicable to any feedstock material which contains gold laminated onto any other substrate that has a differential solubility to gold, whether waste or not. The key characteristic is the ability to delaminate the gold from the underlying substrate. It is directed at recovering gold for reuse and is not believed to be otherwise dependent upon the feedstock. Further purification of the gold may be desirable for preparation for reuse or sale.

What is claimed is:

1. A method of gold recovery from electronic waste, the method comprising the steps of:
(i) Contacting electronic waste containing printed circuit boards having gold electroplated on top of copper electrical contacts with a solution containing acetic acid in combination with hydrogen peroxide, wherein the gold electroplated on top of copper electrical contacts becomes delaminated from the electrical contacts to form gold leaf and wherein the solution then contains a mixture of the delaminated gold leaf and chip debris; and
(ii) Isolating the delaminated gold leaf from the chip debris mixed in the solution by:
a. First adding a solvent and water to the solution containing the delaminated gold leaf mixed with chip debris; and
b. Second adding a surfactant to the solution containing the delaminated gold leaf mixed with the chip debris, solvent and water, wherein the delaminated gold leaf floats upward in the solution and purified gold is obtained.

2. The method of gold recovery from electronic waste from claim 1, wherein the solvent is a hexane, a heptane or an octane.

3. The method of gold recovery from electronic waste from claim 1, wherein the surfactant is polyether siloxane copolymer.
